(19) United States
(12) Patent Application Publication
(10) Pub. No.: US 2009/0135430 A1
(43) Pub. Date: May 28, 2009

(54) Systems and Methods for Reducing Nonlinearity in an Interferometer

(76) Inventor: Miao Zhu, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/945,043

(22) Filed: Nov. 26, 2007

(51) Int. Cl. G01B 9/02

(52) U.S. Cl. 356/487

(57) ABSTRACT

A system for measuring electromagnetic interference, the system comprising: a plane mirror interferometer receiving a first electromagnetic beam and a second electromagnetic beam having a same linear polarization, each of the first and second electromagnetic beams transmitted on separate paths such that the beams are non-overlapping until immediately before detection of the beams, wherein the interferometer includes: a reference surface and a measurement surface, the reference surface reflecting the first beam, and the measurement surface reflecting the second beam; and a polarization beam splitter, wherein the first and second beams enter the polarization beam splitter at a same facet of the polarization beam splitter.

### TECHNICAL FIELD

The present description is related generally to interferometers and, more specifically, to systems and methods for minimizing non-linear error in interferometers.

### BACKGROUND OF THE INVENTION

Michelson-type interferometers are often used in precision displacement measurements. In a Michelson-type interferometer, a “reference” laser beam traverses a reference path, reflects off of a reference surface, and is detected. Similarly, a “measurement” laser beam traverses a measurement path, reflects off of a measurement surface, and is detected. The arrangement of the interferometer is such that a difference in optical length of the measurement path (often called the “measurement arm”) relative to the optical length of the reference path (often called the “reference arm”) causes a relative phase shift between the laser beams. Based the knowledge of the initial difference between the phase of the reference laser beam at the beginning of the reference path and the phase of the measurement laser beam at the beginning of the measurement path, the optical path length difference between the measurement arm and the reference arm can be derived. Detection sub-systems in the interferometer are arranged such that the measurement of the optical path length difference between the measurement arm and the reference arm is insensitive to the initial phase difference of the laser beams.

Ideally, the accumulated phase of the detected interference signal is proportional to the displacement of the measurement surface relative to the reference surface. However, the leakage phenomenon can alter the linear relationship. Leakage occurs when spatial overlap of two signals, combined with non-ideal characteristics of the sources and optical components of the system, cause frequency and phase mixing of the signals. Leakage leads to a repetitive non-linearity in the observed phase shift, and the error can limit the accuracy of the interferometer. This periodic nonlinearity is also known as periodic error, cyclic nonlinearity, cyclic error, etc.

The origin of the periodic nonlinearity has been analyzed in the literature. Several interferometers were designed to reduce/eliminate the periodic nonlinearity. For example, the system described in U.S. Pat. No. 4,856,009 helps to reduce the periodic non-linearity. However, the design employs a retro-reflector in the measurement arm as the measurement surface. Thus, it is difficult to use such a design in a two-dimensional application (wherein the measurement surface can move in more than one dimension), such as in the wafer stage of lithographic machines.

Further, United States Patent Application Publication US 2007/0115478 describes an interferometer that reduces the periodic non-linearity without employing a retroreflector in the measurement arm. However, the system of US 2007/0115478 is a design that can be improved upon, especially with regard to compactness. The background section of US 2007/0115478 provides an instructive discussion of related technology.

Moreover, digital signal processing algorithms have been developed to mitigate the effects of the periodic nonlinearity. However, the use of digital algorithms has its own limitation. For example, such algorithms generally do not work well when the displacement changes very slowly, such as in the calibration procedure of the wafer stage of a lithographic machine.

### BRIEF SUMMARY OF THE INVENTION

Various embodiments of the present invention are directed to systems and methods that reduce cyclic error in a plane mirror interferometer by keeping two input signals separate until they are detected, thereby reducing leakage, as well as using a same polarization for the two input signals, thereby providing for a more compact design.

In one example embodiment, the two input beams are linearly p-polarized and can have the same frequency or different frequencies. The first input beam is split so that one portion becomes the reference beam, and the other portion becomes the measurement beam. The two portions are transmitted through the system so that they accumulate a relative phase difference. The second beam is split into two portions. One portion from the second beam is combined (i.e., spatially overlapped) with the output reference beam, and the other portion of the second beam is combined with the output measurement beam. The combined beams are then detected and analyzed, and the data is used to measure displacement or other physical characteristics. Another example embodiment utilizes two s-polarized input beams.

In another embodiment, one input beam is used as the reference beam, and the other input beam is used as the measurement beam. The beams traverse their respective paths, accumulating relative phase shifts, then are combined and detected. Various embodiments of the invention can be used in differential interferometer applications, two-dimensional applications, and the like.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1A is an illustration of an exemplary system adapted according to one embodiment of the invention;

FIG. 1B is an illustration of an exemplary system adapted according to one embodiment of the invention;

FIG. 2 is an illustration of an exemplary system adapted according to one embodiment of the invention;

FIG. 3A is an illustration of an exemplary system adapted according to one embodiment of the invention;

FIG. 3B is an illustration of an exemplary system adapted according to one embodiment of the invention;

FIG. 4 is an illustration of an exemplary method adapted according to one embodiment of the invention; and

FIG. 5 is an illustration of an exemplary method adapted according to one embodiment of the invention.

### DETAILED DESCRIPTION OF THE INVENTION

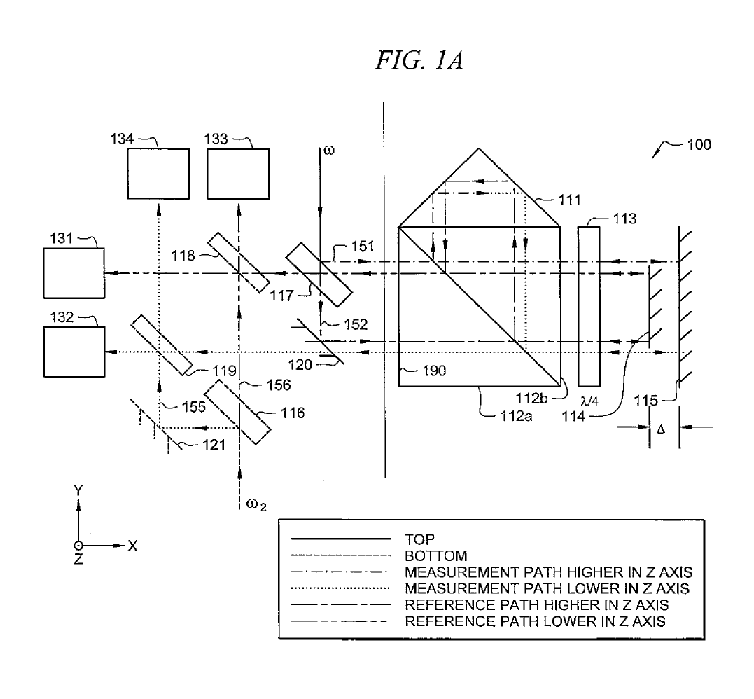

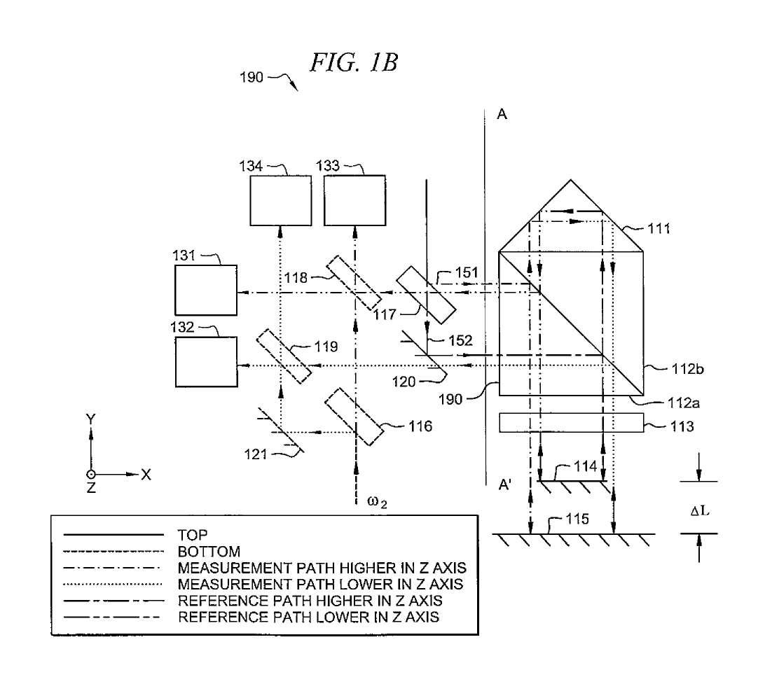

FIG. 1A is an illustration of exemplary system 100 adapted according to one embodiment of the invention. System 100 is a plane mirror interferometer system that includes two input beams, denoted here as ω1 and ω2, each having the same linear polarization. In system 100, ω1 is split into a reference beam and a measurement beam, transmitted through the interferometer subassembly (on the right side of AA′), and then sent to an array of beam splitters on the left side of AA′, where the measurement and reference beams are combined with beam components from ω2 immediately before being detected. In this way, input beams ω1 and ω2 are transmitted in separate paths until they are detected. As explained further, such separate paths reduce leakage, thereby minimizing non-linear error.

Beams ω1 and ω2 can include any wavelength of visible or invisible light as long as the light can be reflected or transmitted with optical components, such as mirrors, prisms, and the like. The respective frequencies can be the same or different. In this example, beams ω1 and ω2 are linearly polarized beams that have the same polarization. Beam ω1 is discussed first.

Beam ω1 enters system 100 and is split by beam splitter 117 into measurement beam 151 and reference beam 152. Measurement beam 151 is reflected into polarizing beam splitter (PBS) 112 at facet 190 of PBS 112 and split by the interface of prisms 112a and 112b. Reference beam 152 is passed to mirror 120, where it is also reflected into PBS 112. At this point both beams 151 and 152 are p-polarized, such that beams 151 and 152 pass through PBS 112, rather than being reflected. Beams 151 and 152 then enter quarter waveplate (i.e., a waveplate with retardation of one quarter wave) 113, the fast axis of which is approximately 45 degrees with respect to the polarization of the polarization of the beams 151 and 152, where polarization is changed from linear to circular. Beam 151 then is transmitted to mirror 115, where it is reflected back into quarter waveplate 113. Beam 152 is reflected from mirror 114 back into quarter waveplate 113.

Mirrors 114 and 115 are plane mirrors—i.e., they have substantially flat reflective surfaces. Thus, system 100 is considered a plane mirror interferometer. Mirrors 114 and 115 are spaced a distance ΔL apart. In this example, the distance ΔL is measured by a relative phase shift that it causes in beams 151 and 152. However, it is also possible to measure changes to ΔL when ΔL is variable. Further, in some embodiments, ΔL may be zero, and another physical measurement may be made, such as refractive index of a transmission medium. It should be noted, however, that various embodiments of the invention are not limited to the specific types of measurement listed herein.

After being reflected from respective mirrors 115 and 114, beams 151 and 152 are transmitted to quarter waveplate 113, wherein their circular polarization is changed to linear s-polarization. S-polarized beams 151 and 152 then are transmitted back into PBS 112, where their changed polarization state causes them to be reflected into retroreflector 111. In this example, retroreflector 111 is a cube corner; however, other embodiments may use other types of retroreflectors, such as a cat's eye. In this example, retroreflector 111 can also be used to perform a correcting function for slight misalignments in mirrors 114 and 115. For example, in embodiments wherein measurement mirror 115 is moveable along the X, Y, and/or Z axes, it may be very difficult to precisely move mirror 115 such that its reflective plane is exactly parallel to its position prior to the move. The misalignment of mirror 115 causes a change in the propagation direction of beam 151. Retroreflector 111, as a cube corner, can correct for these propagation direction errors by ensuring that measurement beam 151 maintains its propagation direction after the second pass to and from mirror 115. This quality makes some embodiments quite usable for applications with moving reference surfaces, such as semiconductor wafer production.

Retroreflector 111 also causes beams 151 and 152 to be transmitted on paths that are in a different plane in the Z-axis. After being retroreflected, beams 151 and 152 are transmitted back into PBS 112 and are reflected due to their s-polarization. Beams 151 and 152 then travel back into quarter waveplate 113, where their polarization is changed to circular polarization. Once again, beams 151 and 152 then are reflected from respective mirrors 115 and 114 and pass through quarter waveplate 113, where their polarization is changed back to linear p-polarization. The p-polarization of beams 151 and 152 allows them to pass through PBS 112 without reflection and toward line AA′.

Since output beams 151 and 152 are in a different plane in the Z-axis than components 117 and 120, they pass underneath components 117 and 120 and toward an array of beam splitters that include beam splitters 118 and 119. Beam 151 is transmitted to beam splitter 119, and beam 152 is transmitted to beam splitter 118. The path of beam ω2 will now be discussed.

Beam ω2 is impinges upon beam splitter 116 where it is split into beam components 155 and 156. While beams 155 and 156 are referred to as “components,” such term is not meant to imply that beams 155 and 156 are not beams in their own rights. Alternatively, beams 155 and 156 can be referred to, respectively, as measurement and reference beams. However, the terminology herein is used as a matter of convenience to minimize confusion with measurement and reference beams 151 and 152.

Beam component 155 is reflected by beam splitter 116 so that it strikes mirror 121 and is reflected so that it impinges upon beam splitter 119. Beam component 156 passes through beam splitter 116 and impinges upon beam splitter 118.

At beam splitter 118, beam 152 and beam component 156 are combined. Specifically, a portion of beam 152 is reflected to photo detector 133, while a portion of beam 152 is passed through to photo detector 131. In the same way, a portion of beam 156 is reflected to photo detector 131, and a portion is passed through to photo detector 133. Thus, portions of beams 152 and 156 are overlapped and sent to photo detectors 131 and 133.

Similarly, at beam splitter 119, portions of beams 151 and 155 are overlapped and sent to photo detectors 132 and 134. Thus, it can be seen in FIG. 1A, that beams ω1 and ω2 are transmitted along separate paths until immediately before detection. In other words, after beams ω1 and ω2 are spatially overlapped, they do not traverse their respective reference or measurement paths any more. Instead, they are provided to detectors 131-134. Spatially overlapping the beams ω1 and ω2 after they pass the reference path and the measurement path, as in system 100, may help to minimize leakage between beams ω1 and ω2, and minimizing leakage can reduce or eliminate cyclic error in embodiments of the invention.

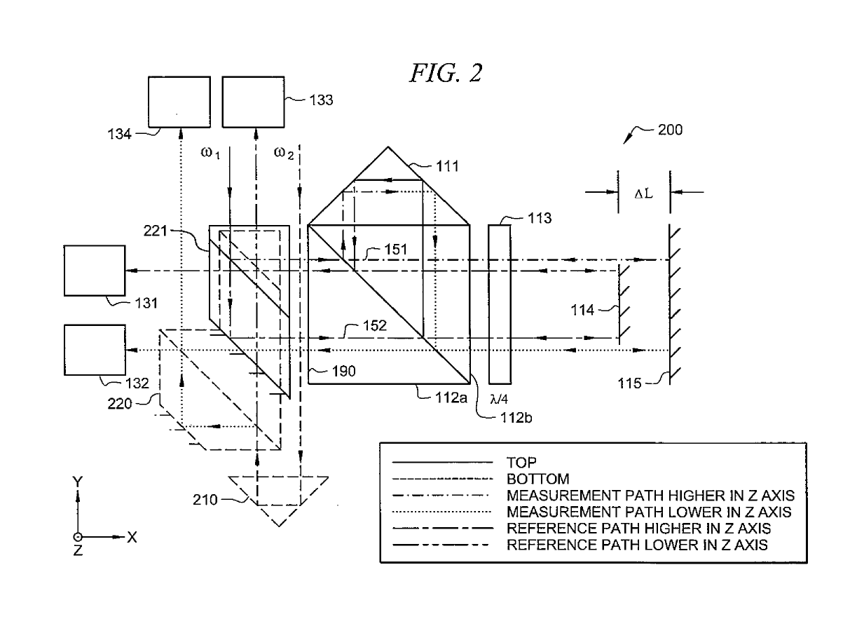

It should be noted that in system 100, the optical path lengths are arranged to provide greater stability of the interferometer. For example, when ΔL is zero, the sum of the optical path length of beam 151 (from beam splitter 117 to beam splitter 119) and the optical path length of beam 156 (from beam splitter 116 to beam splitter 118) is substantially equal to the sum of the optical path length of beam 152 (from beam splitter 117 to beam splitter 118) and the optical path length of beam 155 (from beam splitter 116 to beam splitter 119). Another example is that beam 151 and beam 152 travel substantially the same path lengths in PBS 112, in cube corner 111, and in waveplate 113. “Substantially,” as used in this paragraph, means that any deviation is within the range of acceptable tolerances such that it does not affect the performance of the interferometer (e.g., it is within the range of error of the measuring instruments). Such relationships between the various optical path lengths is a feature that can be incorporated in many embodiments herein, including in FIGS. 1B and 2. Further, in some embodiments, beam splitters 116 and 117 (and 118 and 119) are made of the same material with the same thickness to provide more precision and to minimize errors due to thermal effects.

While not shown in FIG. 1A, signals from detectors 131-134 may be transmitted to one or more processor-based devices for processing and analysis. For example, a general-purpose processor-based device, such as personal computer, can be used to receive signals from detectors 131-134 and to measure ΔL, a change in ΔL, a refractive index in the beam paths, etc., according to methods now known or later developed. In one example, detectors 131-134 are square law detectors, i.e., the output of the detector is proportional to the square of the electric field of the incident electromagnetic beam. The signal from a reference detector can be compared to the signal of a measurement detector to give an indication of the relative phase between the reference signal and the measurement signal. Known relationships between the relative phase shift and differences in measurement path length and reference path length can be used to determine ΔL from the measurements. Other techniques now known or later developed can also be used in some embodiments.

Additionally or alternatively, some embodiments may use more specialized systems, such as a device utilizing an Application Specific Integrated Circuit (ASIC), a Digital Signal Processor (DSP), and/or the like. The invention is not limited to the computing hardware and software used to perform processing and analysis.

It should also be noted that it is possible to utilize two, rather than four, photo detectors in system 100. Specifically, any one of the pairs of detectors can be used if the pair includes both a part of reference signal 152 and measurement signal 151, as well as one of components 155 and 156. For instance, it is possible to eliminate photo detectors 134 and 133, keeping only photo detectors 131 and 132, since a measurement of ΔL (and/or a change in ΔL, etc.) can be made therefrom. However, it may be advantageous in some embodiments to use more than two detectors. For instance, the signals on detectors 131 and 133 are 180° out of phase, and the signals on 132 and 134 are also 180° out of phase. When the signal from detector 131 is subtracted from the signal of detector 133, the large portion of the Direct Current (DC) in the signal cancels out, while the Alternating Current (AC) portions are summed. Canceling out the DC components and summing the AC signal can often help to maximize the signal-to-noise ratio and lead to more precise measurements. The same is true for the signals from detectors 132 and 134. Further, various embodiments of the invention may include beams ω1 and ω2 that have the same or different frequencies, and two or more phase detectors.

In FIG. 1A (and in other figures as well) quarter waveplate 113 is shown as a single-piece optical element. However, for alignment reason and cost reasons, some embodiments use two or more smaller size(s) waveplates instead of a single waveplate.

In FIG. 1A reference mirror 114 is shown as a stand alone optical element. In some embodiments, mirror 114 can be adhered to waveplate 113. In other embodiments, mirror 114 can be implemented by coating the proper spots on the waveplate 113 with reflective coatings. Such variations are within the scope of embodiments. In fact, a combination of these implementations can also be used.

In FIG. 1A reference mirror 114 is shown as a plane mirror. In some embodiments, the two spots which reflect the beam 152 can have an offset along the X-axis provided these two spots are mechanically connected. In this implementation, the X-axis value of the plane for reference mirror 114 is defined as the average value of the two spots' X-axis values. Thus, the term “plane mirror” is used herein according to its ordinary meaning in the optical arts, such that it does not require a single mirror for both reflection spots.

In FIG. 1A the reference mirror 115 is shown as a plane mirror. In some embodiments, the two spots which reflect the beam 151 can have an offset along the X-axis provided these two spots are mechanically connected. In this implementation, the X-axis value of the plane for measurement mirror 115 is defined as the average value of the two spots' X-axis values. The term “plane mirror” is interpreted according to this definition.

FIG. 1B is an illustration of exemplary system 190 adapted according to one embodiment of the invention. In system 190, beams ω1 and ω2 are linearly s-polarized. As explained above with regard to FIG. 1A, the s or p type of the polarization determines whether a beam is passed through or reflected at the interface of pieces 112a and 112b of PBS 112. Since beams ω1 and ω2 are s-polarized in system 190, the measurement and reference paths are essentially ninety degrees from their locations in FIG. 1A. However, despite a slightly different appearance, the functionality of system 190 is the same as that of system 100 (FIG. 1A).

FIG. 2 is an illustration of exemplary system 200 adapted according to one embodiment of the invention. System 200 is similar to system 100 (FIG. 1A), but with a few differences. First, whereas beam splitters 116-119 and mirrors 120 and 121 are shown in FIGS. 1A and 1B as separate components, FIG. 2 utilizes optical components 220 and 221 to perform the beam splitting/combining and reflecting functions. In fact, optical components 220 and 221 perform in the same ways as beam splitters 116-119 and mirrors 120 and 121 (FIGS. 1A and 1B), but are generally easier to manufacture. For instance, optical components 220 and 221 are typically made from several pieces of glass or quartz, polished and adhered together. Various facets, whether internal to components 220 and 221 or external to components 220 and 221 can be made to perform a beam splitting/combining or reflecting function.

In some embodiments, optical components 220 and 221, reflector 210 (which can be a cube corner, a roof prism, or other appropriate optical components), retroreflector 111, PBS 112, and quarter waveplate 113 can be adhered together, thereby creating a monolithic interferometer subsystem. Advantages of monolithic architectures include ease of production and mechanical stability.

Another difference between system 100 (FIG. 1A) and system 200 is that input beams ω1 and ω2 enter system 200 at the same side along the Y-axis, whereas beams ω1 and ω2 enter system 100 on opposite sides. The use of reflector 210, e.g., a roof prism, facilitates such feature of system 200 by reflecting beam ω2 back up into optical component 220. It is often advantageous to have beams ω1 and ω2 input into the interferometer on the same side because it can potentially make for a more compact architecture when implemented in industrial applications. For instance, beams ω1 and ω2 often are supplied from the same laser source (though they may have the same or different frequency) such that beams ω1 and ω2 are transmitted from the same direction anyway.

It should be noted that, similarly to system 100, system 200 keeps beams ω1 and ω2 separate until immediately before detection. Further, system 200 can employ similar configurations of photo detectors (e.g., one pair, two pairs) as described above with regard to system 100.

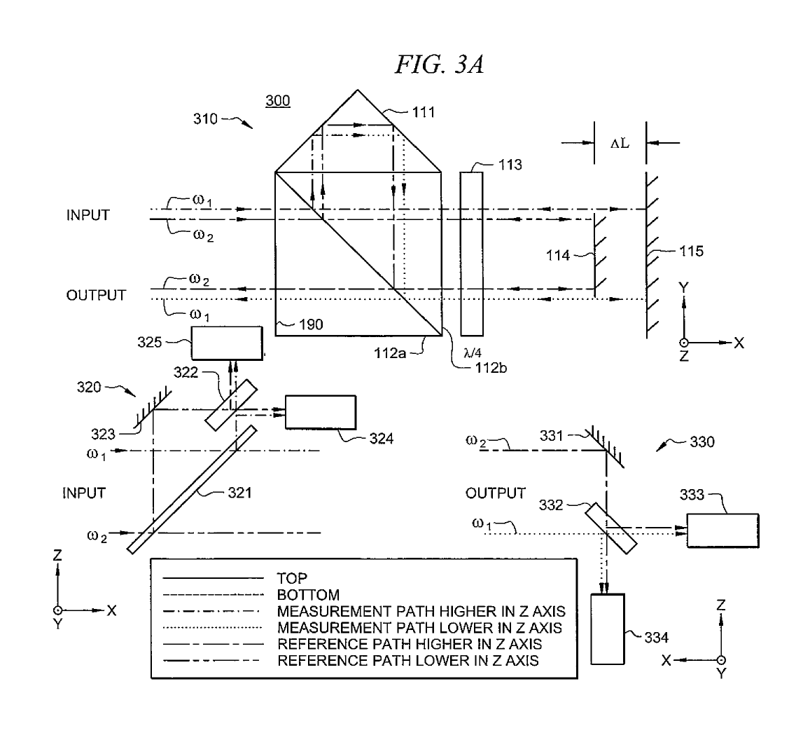

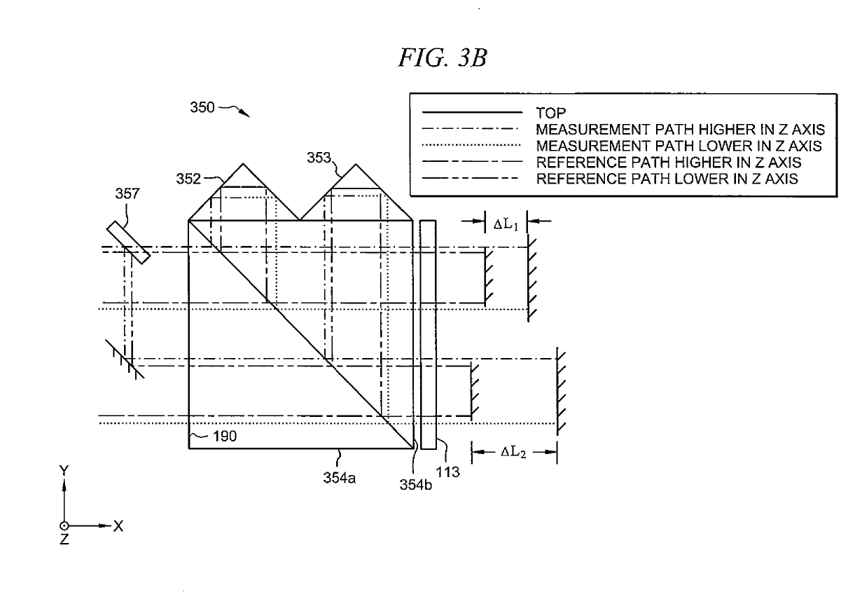

FIG. 3A is an illustration of exemplary system 300 adapted according to one embodiment of the invention. Similar to the systems described above with regard to FIGS. 1A, 1B and 2, system 300 keeps beams ω1 and ω2 separate until immediately before detection. However, system 300 uses beams ω1 and ω2 as respective measurement and reference beams, whereas the systems of FIGS. 1A, 1B and 2 split each of beams ω1 and ω2 into a measurement beam and a reference beam. FIG. 3A illustrates one technique for providing a system that uses a single reference detector or a single pair of reference detectors for a plurality of different measurement channels.

System 300 includes plane mirror optical subsystem 310, reference detection subsystem 320, and measurement detection subsystem 330. In some embodiments, system 300 may include multiple optical subsystems (such as subsystem 310), each with its own measurement detection subsystem (such as subsystem 330), and each using the same reference detection subsystem (such as subsystem 320). In many embodiments, reference beam ω2 traverses an optical path before it reaches the interferometer system. The optical path of beam ω2 is different from the path that measurement beam ω1 traverses. In addition, one or both of the optical path lengths are variable in some embodiments.

Accordingly, in system 300, reference detection subsystem 320 measures the phase difference between beams ω1 and ω2 when they reach optical subsystem 310. Beams ω1 and ω2 enter subsystem 320, wherein they impinge on beam splitter 321. A portion of beam ω1 passes through beam splitter 321, while another portion is reflected to beam splitter 322. Similarly, a portion of beam ω2 is passed through beam splitter 321, while another portion is reflected to mirror 323 and then to beam splitter 322. Portions of beams ω1 and ω2 are combined at beam splitter 322, some of which are passed to reference detector apparatus 324. Reference detection subsystem 320, in one example, includes one or more photo detectors and one or more processor-based devices to analyze the combined signals and discern the phase difference between the beam ω1 and the beam ω2 before the beams enter optical subsystem 310. Data produced by subsystem 320 is then used by one or more interferometers as the reference signal data in their calculations. Further, the portion of the combined beams that is transmitted along the Z-axis in subsystem 320 may be fed to another detection/processing device (such as device 325) or simply disregarded.

As mentioned above, system 300 can, in some embodiments, include multiple interferometers receiving the same reference beam ω2. However, for convenience, FIG. 3A shows only a single optical subsystem 310 and measurement detection subsystem 330. It is to be understood, though, that system 300 is scalable by adding one or more additional subsystems similar to or the same as subsystems 310 and 330.

Moving on to optical subsystem 310, beams ω1 and ω2 are received. Both beams ω1 and ω2 are linear p-polarized, so they pass through PBS 112, entering at facet 190. Quarter waveplate 113 changes the polarization to circular, and beams ω1 and ω2 strike and reflect off of their respective mirrors 115 and 114. Beams ω1 and ω2 pass through quarter waveplate 113 where their polarization is changed to linear s-polarization. Beams ω1 and ω02 reach the polarization beam splitter 112 and are reflected toward cube corner 111. Cube corner 111 reflects beams ω1 and ω2 into PBS 112, and since beams ω1 and ω2 are still in s-polarization when they hit the polarization beam splitter, beams ω1 and ω2 get reflected so they travel toward mirrors 114 and 115. Beams ω1 and ω2 go through quarter waveplate 113, take on circular polarization, reflect off of mirrors 115 and 114a second time, and travel through quarter waveplate 113 one more time, where polarization is switched to linear p-polarization. Beams ω1 and ω2 pass through polarization beam splitter 113 and come out as the output beams.

Optical subsystem 310 is associated with measurement detection subsystem 330, such that output beams ω1 and ω2 are then fed to subsystem 330. Beam ω2 is reflected by mirror 331 into beam splitter 332, where it is combined with beam ω1. At least one of the combined beams is then provided to measurement detector apparatus 333. Measurement detector apparatus 333, in one example, includes one or more photo detectors and one or more processor-based devices to analyze the combined signals and discern the relative distance traversed by output beams ω1 and ω2. In some examples, measurement detection subsystem 330 includes an input for data from reference detection subsystem 320 so that its measurement can compensate for the phase difference between beam ω1 and beam ω2 accumulated before entry to the interferometer. Further, the portion of the combined beams that is transmitted along the Z-axis in subsystem 330 may be fed to another detection/processing device (e.g., device 334) or simply disregarded.

Similar to the embodiments shown above in FIGS. 1A, 1B and 2, system 300 does not spatially overlap beams ω1 and ω2 until immediately before detection. In this case, wherein beams ω1 and ω2 are used as measurement and reference beams, respectively, the spatial overlapping of the beams does not occur until after the relative phase shift caused by the measured phenomena (e.g., displacement ΔL, change in ΔL, air refractive index in the beam paths, etc.) has substantially occurred.

It should be noted that in system 310, the optical path lengths are arranged to provide greater stability of the interferometer. For example, when ΔL is zero, the sum of the optical path length of beam ω) (from beam splitter 321 to beam splitter 332) and the optical path length of beam ω2 (from beam splitter 321 to beam splitter 322) is substantially equal to the sum of the optical path length of beam ω2 (from beam splitter 321 to beam splitter 332) and the optical path length of beam ω1 (from beam splitter 321 to beam splitter 322). Another example is that beam ω1 and beam ω2 travel substantially the same path lengths in PBS 112, in cube corner 111, and in waveplate 113, “Substantially,” as used in this paragraph, means that any deviation is within the range of acceptable tolerances such that it does not affect the performance of the interferometer (e.g., it is within the range of error of the measuring instruments). Such relationships between the various optical path lengths is a feature that can be incorporated in many embodiments herein, including in FIG. 3B. Further, in some embodiments, beam splitters 322 and 332 are made of the same material with the same thickness to provide more precision and to minimize errors due to thermal effects.

FIG. 3B is an illustration of exemplary system 350 adapted according to one embodiment of the invention. System 350 receives an input in a same or similar fashion as shown with regard to system 300 (FIG. 3A); however, system 350 splits the input measurement beam ω1 and reference beam ω2 at input beams splitter 351, thereby creating two sets of measurement and reference beams. System 350 includes two measurement and reference paths. The first measurement/reference path measures ΔL1 and utilizes retroreflector 352 in a manner similar to the manner in which ΔL is measured in FIG. 3A. The beams from the first reference/measurement paths are output as output 1. The second measurement/reference path measures ΔL2 and utilizes retroreflector 353. The beams from the second reference/measurement paths are output as output 2. Both sets of reference/measurement paths utilize PBS 354 and quarter waveplate 113. The output beams are then analyzed and processed, as described earlier.

System 350 is an illustration of one embodiment using stacked interferometers. Other techniques may use different configurations or more than two interferometers while still falling within the scope of various embodiments. For example, although the two interferometers are stacked along X-axis in FIG. 3B, they can alternatively be stacked along the Z-axis, as well.

Various embodiments of the invention may provide one or more advantages over prior art systems. For example, keeping the respective electromagnetic beams separate until they are detected can minimize leakage, thereby minimizing cyclic error. Further, using the same linear polarization for ω1 and ω2 when they enter the interferometer system can be used to provide for a more compact design. For instance, United States Patent Application Publication US 2007/0115478 describes a plane mirror interferometer system that provides separate paths for a first and a second electromagnetic beam, denoted by f1 and f2, until they are detected. However, the interferometer system of US 2007/0115478 appears to use signals f1 and f2 with orthogonal linear polarizations. The polarization of a beam entering the interferometer system determines the path taken by the beam, since different polarizations will typically cause a given optical element, such as a PBS, to act differently on the beam. The use of orthogonal linear polarizations for the two beams entering the system typically results in a system that includes two beam paths in different optical components after the beams pass through the PBS. For instance, in US 2007/0115478, the paths of the two signals do not share one or more optical components (e.g., quarter waveplates), thereby requiring a design that duplicates some features. In addition, the optical characteristics of these duplicated components (e.g., quarter waveplates) typically are substantially identical in order to maintain the stability of the interferometer, thereby adding complexity to an already complex system.

By contrast, embodiments of the present invention can use the same quarter waveplate for reference and measurement beams (e.g., plate 113 of FIGS. 1A, 1B, 3A). At least for this reason, various embodiments of the present invention can provide for more compact designs and lower manufacturing cost.

Compare the beam paths in PBS 112 and cube corner 111 between the first pass and the fourth pass of the interface between 112a and 112b. When measurement beam ω1 and reference beam ω2 have the same linear polarization, both paths are in 112b and 111. When measurement beam ω1 and the reference beam ω2 have orthogonal linear polarizations, part of the path for one of the beams is in 112b while part of the path for the other of the beams is in 112a. In this case of using orthogonal linear polarizations the interferometer is more susceptible to the temperature change and the temperature gradient to the extent that such temperature phenomena affect pieces 112a and 112b differently.

Another disadvantage of using the orthogonal linear polarizations in the measurement beam ω1 and reference beam ω2 is that the polarizations of the two interferencing beams need to be changed into one polarization before the detection. This is not shown in the figures of US2007/0115478. Although this can be readily accomplished using polarization optical components such as polarizors or waveplates, the extra optical components and assembling make the interferometer more expensive and less robust than various embodiments of the present invention.

Another advantage of using the same polarization in the measurement beam and the reference beam is that Non-Polarizing Beam Splitters (NPBS, e.g., 118 and 119 of FIGS. 1A and 1B, the coating on component 220 of FIG. 2, and the like) can be used to combine the beams before the detection. When the orthogonal linear polarizations are used, PBSs are typically employed to combine the beams. Further, in general PBSs cost more than NPBSs. Thus, the system using the same polarization in the measurement beam and the reference beam can often take advantage of lower manufacturing cost.

Additionally, various embodiments of the invention can be used in differential interferometer applications, In differential interferometer applications, only the change in the displacement in the measurement arm relative to the reference arm (e.g., ΔL of FIG. 1A) is measured. Thus, if the reference mirror and the measurement mirror are arranged in parallel planes and move together such that the distance between them, ΔL, is kept constant, the measured result is constant. Various embodiments of the present invention can be used to implement differential interferometer systems, which is facilitated by the fact that the two input signals have the same linear polarization, thereby allowing the two input beams to travel in parallel and to strike two parallel mirrors (as in FIGS. 1A, 1B, and 3A).

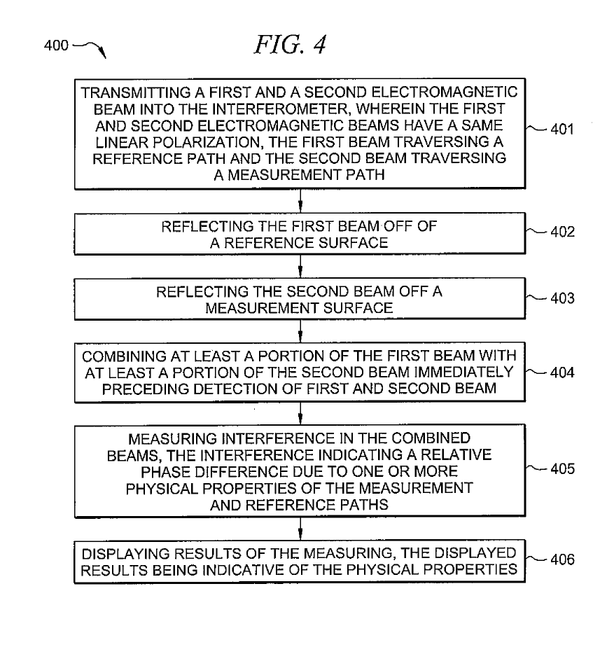

FIG. 4 is an illustration of exemplary method 400 adapted according to one embodiment of the invention. Method 400, in some embodiments, is performed by a plane mirror interferometer system the same as or similar to those shown in FIGS. 3A and 3B.

In step 401, a first and a second electromagnetic beam are transmitted into an interferometer, wherein the first and second electromagnetic beams have a same linear polarization, the first beam traversing a reference path and the second beam traversing a measurement path. Step 401 is performed in some embodiments by one or more laser systems. For instance, in some examples, the first and second electromagnetic beams are produced by the same laser system. In fact, in some embodiments, a single laser system produces at least two different frequencies of laser light, and the two different frequencies are used, respectively, as the first and second electromagnetic beams. In other embodiments, the first and second electromagnetic beams are provided by two different laser systems. For instance, the laser system providing a reference beam can be placed at a relatively far distance from the laser system providing a measurement beam. In some cases, a frequency/phase locking system (not shown) is used to reduce the relative frequency/phase noise between these two laser systems.

In step 402, in the interferometer, the first beam is reflected off of a reference surface. In step 403, the second beam is reflected off of a measurement surface. It is possible in some embodiments that the reference and measurement surfaces may be placed a distance ΔL apart (e.g., when measuring ΔL) or may be separated by no distance ΔL (e.g., when measuring index of refraction of a transmission medium). In fact, when ΔL is zero, some example embodiments employ a common reflective surface as the first and second reflective surfaces.

In step 404, at least a portion of the first beam is combined with at least a portion of the second beam immediately preceding detection of first and second beam. In other words, the first and second electromagnetic beams are transmitted along separate paths until they are spatially overlapped immediately before detection.

In step 405, interference is measured in the combined beams, the interference indicating a relative phase difference due to one or more physical properties of the measurement and reference paths. The interference can be measured according methods now known or later developed, including well-known interference measurement techniques. Examples of physical properties that may cause relative phase shifts in the first and second electromagnetic beams include, but are not limited to, distance and refractive index of transmission media. Step 405 may be performed, for example, by a processor-based device, as mentioned earlier.

In step 406, results of the measuring are displayed, the displayed results being indicative of the physical phenomena. In one example, a processor-based device executes programs to render the results on a monitor for a user. In another example, the results are used to control the displacement ΔL. In yet another example, the distance ΔL is fixed in the interferometer and the measured results are used to control the laser frequency.

Method 400 is shown as a series of discrete steps, which is for convenience of illustration only. It should be noted that various embodiments are not limited to the specific implementation shown in FIG. 4. On the contrary, various embodiments may add, omit, or rearrange steps. For instance, steps 402 and 403 may be performed concurrently or may be performed such that step 403 happens first in time. Further, in many embodiments, steps 402 and 403 are performed more than once, as in the embodiment shown in FIGS. 3A and 3B where respective light beams were reflected off of their corresponding mirrors twice. Still further, various embodiments measure an initial phase difference accumulated by the first and second electromagnetic beams before they enter the interferometer.

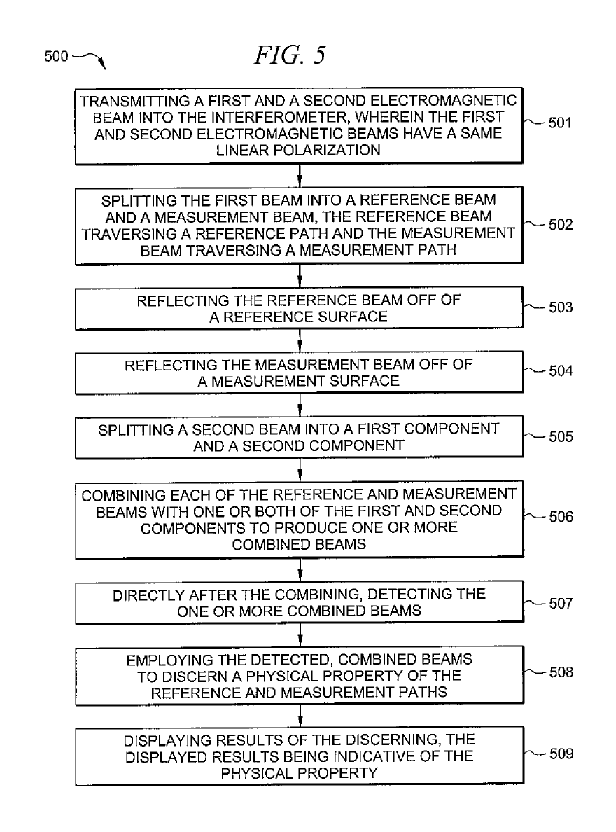

FIG. 5 is an illustration of exemplary method 500 adapted according to one embodiment of the invention. Method 500, in some embodiments, is performed by a plane mirror interferometer system the same as or similar to those shown in FIGS. 1A, 1B and 2.

In step 501, a first and a second electromagnetic beam are transmitted into the interferometer, wherein the first and second electromagnetic beams have a same linear polarization. Step 501 is performed in some embodiments by one or more laser systems. For instance, in some embodiments, the first and second electromagnetic beams are produced by the same laser system. In fact, in some embodiments, the laser system produces at least two different frequencies of laser light, and the two different frequencies are used, respectively, as the first and second electromagnetic beams. In some embodiments, the first and second electromagnetic beams are provided by two different laser systems. For instance, the laser system providing a reference beam can be placed at a relatively far distance from the laser system providing a measurement beam. In this case, if it is necessary, a frequency/phase locking system (not shown) is used to reduce the relative frequency/phase noise between these two laser systems.

In step 502, the first beam is split into a reference beam and a measurement beam, the reference beam traversing a reference path and the measurement beam traversing a measurement path. In step 503, the reference beam is reflected off of a reference surface. In step 504, the measurement beam is reflected off of a measurement surface. It is possible in some embodiments that the reference and measurement surfaces may be placed a distance ΔL apart (e.g., when measuring ΔL) or may be separated by no distance ΔL (e.g., when measuring index of refraction of a transmission medium). In fact, when ΔL is zero, some example embodiments employ a common reflective surface as the first and second reflective surfaces.

In step 505, the second beam is split into a first component and a second component. In step 506, each of the reference and measurement beams are combined with one or both of the first and second components to produce one or more combined beams. For instance, in the embodiments shown in FIGS. 1A, 1B and 2, the reference beam exits the PBS as a single beam that is split into two separate beams, then each is spatially overlapped with the second component of the second beam. Also in the embodiments shown in FIGS. 1A, 1B and 2, the measurement beam exits the PBS as a single beam that is split into two separate beams, then each is spatially overlapped with the first component of the second beam. Then, the four combined beams are detected. It is possible that some embodiments may detect two beams, rather than four. For instance, one embodiment detects a first combined beam that includes at least a component of the reference beam combined with at least a component of the second beam and detects a second combined beam that includes at least a component of the measurement beam combined with at least a component of the second beam.

In step 507, the combined beams are detected immediately after the combining. In step 508, the detected, combined beams are employed to discern a physical property of the reference and measurement paths. For instance, in some embodiments the reference and measurement paths have different lengths. In another example embodiment, the reference and measurement paths include different transmission media. The combined beams can be used to measure the difference in lengths or the refractive index of a transmission medium. In one example, two or more of the beams have relative phase shifts, and the phase shifts can be measured according methods now known or later developed, including well-known interference measurement techniques. Step 508 may be performed, for example, by a processor-based device, as mentioned earlier.

In step 509, the results discerning the physical property are displayed. In one example, a processor-based device executes programs to render the results on a monitor for a user. In another example, the results are used to control the displacement ΔL. In yet another example, the distance ΔL is fixed in the interferometer and the measured results are used to control the laser frequency.

Method 500 is shown as a series of discrete steps, which is for convenience of illustration only. It should be noted that various embodiments are not limited to the specific implementation shown in FIG. 5. On the contrary, various embodiments may add, omit, or rearrange steps. For instance, steps 503 and 504 may be performed concurrently or may be performed such that step 504 happens first in time. Further, in many embodiments, steps 503 and 504 are performed more than once, as in the embodiment shown in FIGS. 1A, 1B and 2 where respective light beams were reflected off of their corresponding mirrors twice.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for measuring electromagnetic interference, said system comprising:
a plane mirror interferometer receiving a first electromagnetic beam and a second electromagnetic beam having a same linear polarization, each of said first and second electromagnetic beams transmitted on separate paths such that said beams are non-overlapping until immediately before detection of said beams, wherein said interferometer includes:
a reference surface and a measurement surface, said reference surface reflecting said first beam, and said measurement surface reflecting said second beam; and
a polarization beam splitter, wherein said first and second beams enter said polarization beam splitter at a same facet of said polarization beam splitter.

2. The system of claim 1 wherein a measurement arm and a reference arm of said interferometer are parallel.

3. The system of claim 2 wherein said first and second surfaces are spaced a distance ΔL apart, said interferometer further including a measurement subsystem to measure ΔL.

4. The system of claim 3, said system further comprising:
a first beam splitter at an input to said system allowing a portion of each of said first and second beams to pass therethrough and reflecting another portion of each of said beams to a second beam splitter, said second beam splitter combining said portions of each said first and second beams that are reflected by said first beam splitter; and
a third beam splitter at an output of said system combining said first and second beams that have reflected off of said reference and measurement surfaces, respectively, wherein a first path length sum and a second path length sum are substantially equal, and wherein ΔL is zero;
said first path length sum including an optical path length of said second beam from said first beam splitter to said third beam splitter plus an optical path length of said first beam from said first beam splitter to said second beam splitter; and
said second path length sum including an optical path length of said first beam from said first beam splitter to said third beam splitter plus an optical path length of said second beam from said first beam splitter to said second beam splitter.

5. The system of claim 3 wherein said interferometer further comprises a retro-reflector separate from said first and second reflective surfaces correcting for an angular tilt in one or more of said first and second reflective surfaces.

6. The system of claim 3 wherein one or both of said first and second reflective surfaces are configured to be moved such that ΔL is variable, and said measurement subsystem is operable to measure a change in ΔL.

7. A system for measuring electromagnetic interference, said system comprising:
a plane mirror interferometer receiving a first electromagnetic beam and a second electromagnetic beam having a same linear polarization, each of said first and second electromagnetic beams transmitted on separate paths such that said beams are non-overlapping until immediately before detection of said beams, and said first beam is split into a reference beam and a measurement beam, wherein said interferometer includes:
a reference surface and a measurement surface, wherein said reference surface reflects said reference beam, and said measurement surface reflects said measurement beam; and
a polarization beam splitter, wherein said reference beam and said measurement beam enter said polarization beam splitter at a same facet of said polarization beam splitter,
said interferometer splitting said second beam into a first and a second beam component and combining one or both of said first and second beam components with each of said reference beam and said measurement beam.

8. The system of claim 7 wherein said first and second surfaces are spaced a distance ΔL apart, and wherein said interferometer combines said one or both of said first and second beam components with each of said reference beam and said measurement beam after said reference beam and said measurement beam have acquired a relative phase shift due to said distance ΔL.

9. The system of claim 8, said system further comprising:
a first beam splitter splitting said first beam into said reference beam and said measurement beam;
a second beam splitter splitting said second beam into said first and second beam components;
a third beam splitter combining said measurement beam and said first beam component; and
a fourth beam splitter combining said reference beam and said second beam component, wherein a first path length sum and a second path length sum are substantially equal, and wherein ΔL is zero;
said first path length sum including an optical path length of said measurement beam from said first beam splitter to said third beam splitter plus an optical path length of said second beam component from said second beam splitter to said fourth beam splitter; and
said second path length sum including an optical path length of said reference beam from said first beam splitter to said fourth beam splitter plus an optical path length of said first beam component from said second beam splitter to said third beam splitter.

10. The system of claim 7 wherein said interferometer further comprises a retro-reflector separate from said reference surface and said measurement surface and correcting for an angular tilt in one or more of said reference surface and said measurement surface.

11. The system of claim 10 wherein one or both of said first and second reflective surfaces are configured to be moved such that ΔL is variable, and said measurement subsystem is operable to measure a change in ΔL.

12. The system of claim 7 wherein said interferometer comprises:
a first electromagnetic source transmitting said first beam to said interferometer; and
a second electromagnetic source transmitting said second beam to said interferometer, said first and second electromagnetic sources arranged on a same side of said interferometer.

13. The system of claim 7 wherein said first and said second beam have different frequencies.

14. A method for operating a plane mirror interferometer, said method comprising:
transmitting a first and a second electromagnetic beam into said interferometer at a same facet of a polarization beam splitter, wherein said first and second electromagnetic beams have a same linear polarization, said first beam traversing a reference path and said second beam traversing a measurement path,
reflecting said first beam off of a reference surface;
reflecting said second beam off of a measurement surface; and
combining at least a portion of said first beam with at least a portion of said second beam immediately preceding detection of first and second beams.

15. The method of claim 14 further comprising:
measuring interference in the combined beams, the interference indicating a relative phase difference of said first and second electromagnetic beams due to a physical property of the measurement and reference paths.

16. The method of claim 15 further comprising:
discerning said physical property from said measurement.

17. The method of claim 16 further comprising:
displaying results of the measuring, the displayed results being indicative of the physical property.

18. The method of claim 14 wherein said transmitting a first and a second electromagnetic beam into said interferometer comprises:
transmitting said first and second electromagnetic beams into said interferometer system from a same direction.

19. The method of claim 14, wherein said reference and measurement surfaces are spaced apart by a distance ΔL and a medium of said reference path has a first refractive index, and said measurement path has a second refractive index, said method further comprising:
measuring interference in said combined beams, said interference indicating a relative phase difference due to said distance ΔL and due to any difference between the first and second refractive indices.

20. The method of claim 14, wherein said first and second electromagnetic beams have a relative phase difference therebetween upon entry to said interferometer, said method further comprising:
measuring said relative phase difference.
